(19) United States
(12) Patent Application Publication
(10) Pub. No.: US 2011/0165832 A1
(43) Pub. Date: Jul. 7, 2011

(54) ELECTRIC COMPARTMENT EXHAUST DUCT WITH ENHANCED AIR COOLING FEATURES

(75) Inventor: Mark G. Smith, Canton, MI (US)

(73) Assignee: Ford Global Technologies, LLC, Dearborn, MI (US)

(21) Appl. No.: 12/862,824

(22) Filed: Aug. 25, 2010

(51) Int. Cl. B60H 1/00; B60H 1/22

(52) U.S. Cl. 454/139; 454/160

(57) ABSTRACT

For cooling electric equipment in an electric automotive vehicle, an exhaust duct carrying exhaust air flowing from an electric compartment located behind and/or beneath a seat extends beneath the seat and exhausts into the passenger cabin. The exhaust duct has at least one air induction opening therein downstream from the electric compartment to draw auxiliary cooling air from the passenger cabin into the duct to join with the exhaust air. As exhaust air from the electric compartment passes through the exhaust duct, auxiliary cooling air is drawn into the exhaust duct through the air induction openings and mixes with the warmer air from the compartment to reduce the temperature of the air mixture exiting the exhaust duct. Air mixing features may be located inside the exhaust duct to improve mixing of the air flow from the electric compartment with the auxiliary cooling air.

### BACKGROUND

1. Technical Field

The present invention relates to electrically-powered automotive vehicles having air-cooled electrical components.

2. Background Art

Electrically-powered vehicles such as hybrid electric vehicles (HEV), plug-in HEVs, pure electric vehicles, etc., generally include electrical components (batteries, battery chargers, converters (DC/DC, AC/DC, and/or DC/AC), and/or inverters) that produce some amount of waste heat during operation. Such electric components, particularly high-voltage components, may generate a significant amount of waste heat and so may require some degree of active cooling. This cooling may be accomplished by providing a relatively constant flow of air into the electric compartment from within the vehicle passenger cabin, the cargo compartment, and/or the exterior of the vehicle.

In one conventional vehicle layout, a compartment containing electrical components is located immediately behind and/or beneath one or more of the occupants seating positions. Cooling air is forced or drawn through the electric compartment by a fan and the warm exhaust air is expelled into the passenger compartment and/or cargo compartment through an exhaust duct extending beneath the rear seat.

Under certain conditions the cooling air exiting the exhaust duct into the passenger compartment may be so warm as to raise the temperature in the seating area to an uncomfortable level.

### SUMMARY

According to an embodiment of the disclosure, a cooling system for electric equipment housed in an electric compartment located behind and/or beneath a seat forward of an automotive vehicle comprises an exhaust duct carrying exhaust air flowing from the electric compartment and extending beneath the seat and exhausting into the passenger cabin. The exhaust duct has at least one air induction opening therein downstream from the electric compartment and drawing cooling air from the passenger cabin into the duct to join with the exhaust air. As exhaust air from the electric compartment passes through the exhaust duct, auxiliary cooling air is drawn into the exhaust duct through the air induction openings and mixes with the warmer air from the compartment to reduce the temperature of the air mixture exiting the exhaust duct. Air mixing features may be located inside the exhaust duct to improve mixing of the air flow from the electric compartment with the auxiliary cooling air.

### BRIEF DESCRIPTION OF THE DRAWINGS

Embodiments of the present invention will now be described by way of example only with reference to the accompanying drawings in which:

FIG. 1 is a simplified schematic view of a passenger vehicle interior including an electric compartment and a seating position;

FIG. 2 is a cross section taken along lines 2-2 of FIG. 1;

FIG. 3 is detail view of an air induction opening in a duct;

FIG. 4 is a schematic cutaway view of an electric compartment exhaust duct; and

FIG. 5 is a schematic cross sectional view of an electric compartment exhaust duct showing air induction openings.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

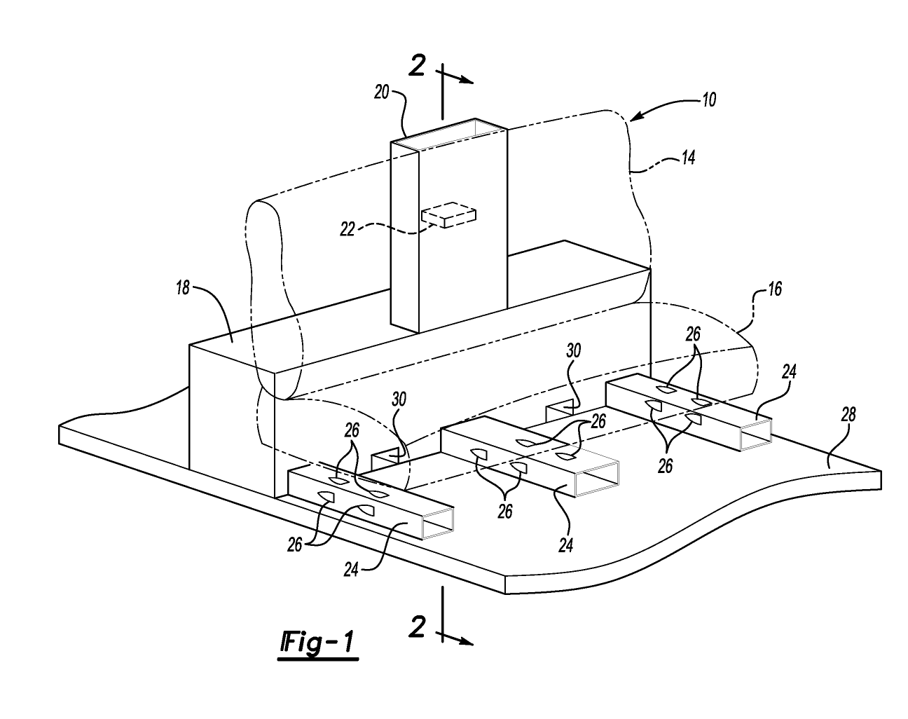

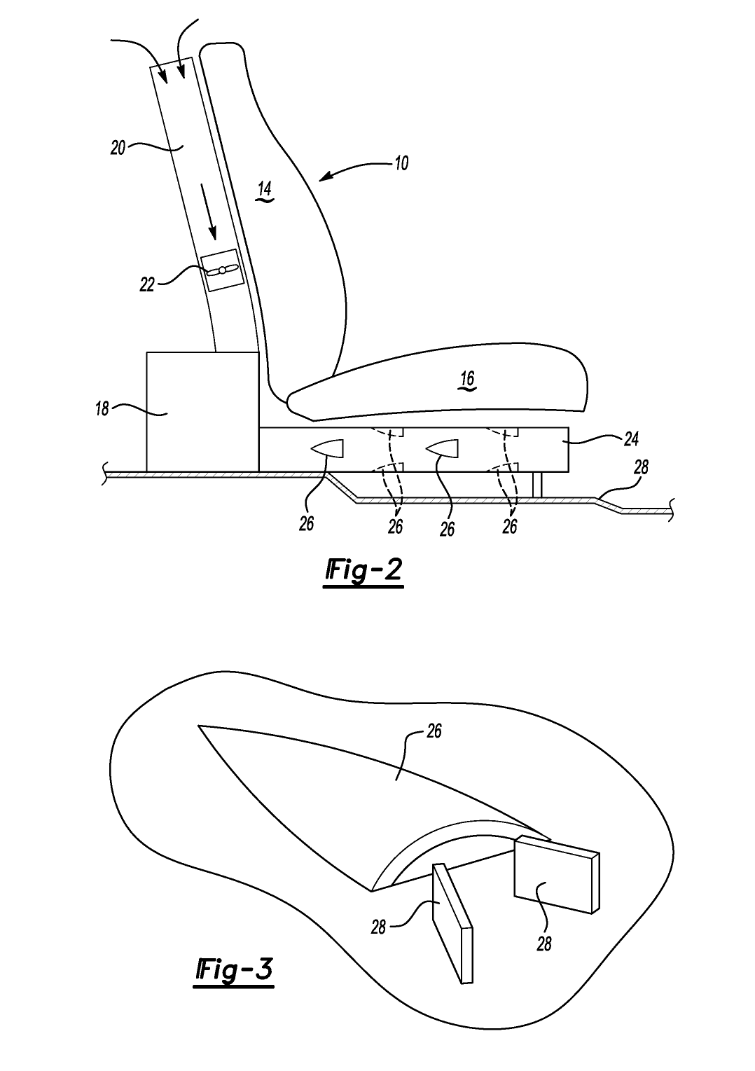

Referring to FIGS. 1 and 2, a seat or seating row 10 is located within an automotive vehicle interior cabin and comprises a seat back 14 and a lower seat cushion 16. An electric equipment compartment 18 is located immediately behind the seating row 10 and contains electrical components related to storing, conditioning, and/or delivering electric power to a vehicle electric traction motor (not shown). An air intake duct 20 is located behind seat back 14 and extends upwardly from electric compartment 18. The upper/intake end of intake duct 20 may be located immediately behind an upper portion of seat back 14 adjacent to what is commonly referred to as the package tray area, as shown. A fan 22 may be located within intake duct 20 or electric compartment 18 to induce a flow of cooing air through the compartment.

One or more exhaust ducts 24 extend forward from electric compartment 18 and pass beneath seat cushion 16. The three exhaust ducts 24 illustrated in FIG. 1 are by way of example only, as any number of exhaust ducts may be present. Also, ducts 24 are illustrated as being generally rectangular in cross section, however they may be of any appropriate cross sectional shape to meet package requirements beneath seat cushion 16.

Exhaust ducts 24 include a plurality of air induction openings 26 located at various spots around the outer surfaces. Air induction opening 26 may be of any size and shape, however they may favorably take the form of ramps or louvers that project inwardly from the outer walls of ducts 24. Air induction openings 26 may be located on any surface of exhaust ducts 24 such as upper, lower, or left/right lateral surfaces. Air induction openings 26 are most appropriately located at those areas of the ducts that are most readily supplied with an air flow. For example, if an exhaust duct is relatively tightly sandwiched between the compartment floor 28 and seat cushion 16 air flow to the upper and lower surfaces of the duct may be restricted. Accordingly, it may be not be effective to position air inlet openings 26 on the top and/or bottom surfaces of the duct, since inlets on the lateral surfaces will more effectively draw air into the exhaust duct. If, however, there is sufficient clearance between the top and/or bottom surfaces of the exhaust duct 24 and adjacent vehicle structure for a relatively free supply of air, then those surfaces are appropriate for the air induction opening.

Openings or tunnels 30 through electric compartment 18 may be provided that connect the space beneath seat cushion 16 and between ducts 24 with the vehicle interior rearward of the electric compartment. Such tunnels 30 permit auxiliary cooling air to flow forward from the rear vehicle interior and reach inlet ducts 26.

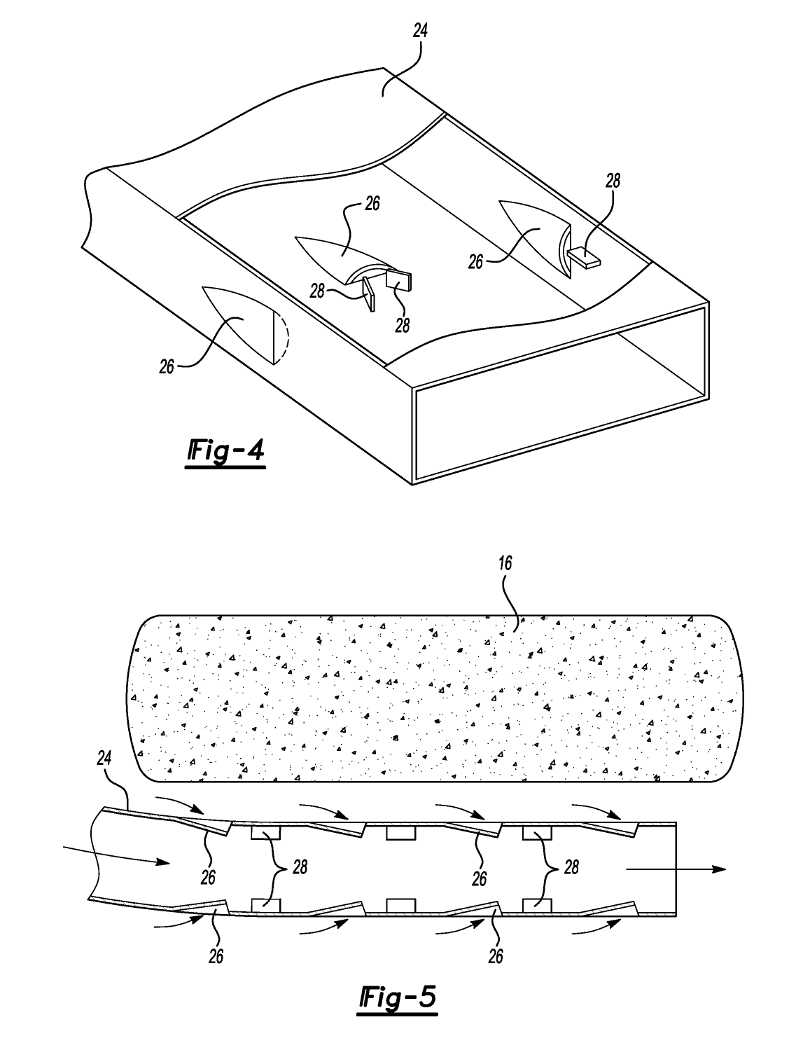

In FIGS. 3 and 4 inlet openings 26 are shown in the form of semi-conical louvers, but this is by way of example only as the openings may have any appropriate shapes such as semi-pyramid or half-circular. Inlet openings 26 may be similar in shape to what are commonly referred to as “NACA ducts” or “NACA inlets” used to scoop or draw airflow into a moving vehicle such as an automobile or aircraft. Flow mixing features such as vanes or baffles 28 may be located on the inner surfaces of exhaust ducts 24 in order to impart a swirl or other relative motion of the auxiliary cooling air after it is drawn into the exhaust duct through inlet openings 26.

As exhaust air from electric compartment 18 flows through exhaust duct 24, the internal flow will draw auxiliary cooling air from outside of the exhaust ducts inwardly through air induction openings 26, as indicated in FIG. 5. The cooler auxiliary air drawn in through openings 26 mixes with the warmer exhaust air coming directly from electric compartment 18, thereby lowering the temperature of the air mixture that exits the exhaust ducts in the foot well area forward of seat cushion 16.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed:

1. Apparatus for cooling exhaust air from an electric equipment compartment located behind a seat in a passenger cabin of an automotive vehicle comprising:
an exhaust duct carrying exhaust air flowing from the electric compartment and extending beneath the seat and exhausting into the passenger cabin, the exhaust duct having at least one air induction opening therein downstream from the electric compartment and drawing cooling air from the passenger cabin into the duct to join with the exhaust air.

2. The apparatus according to claim 1 further comprising a ramp surface projecting inwardly into an interior of the duct adjacent the air induction.

3. The apparatus according to claim 1 further comprising at least one flow mixing feature inside of the duct contributing to a mixing of the cooling air with the exhaust air flows inside the duct.

4. The apparatus according to claim 3 wherein the at least one flow mixing feature is a fixed vane located adjacent the air induction opening.

5. The apparatus according to claim 1 wherein the exhaust duct has an outlet opening located adjacent to a footwell forward of the seat, and the air induction opening is located beneath the seat.

6. The apparatus according to claim 1 further comprising a fan forcing cooling air through the electric compartment and into the exhaust duct.

7. Apparatus for an automotive vehicle having an electric equipment compartment adjacent to a passenger cabin comprising:
a seat forward of the electric compartment; and
an exhaust air duct extending forward from the electric compartment and beneath the seat, and comprising a wall having at least one air induction opening therein downstream from the electric compartment, the air induction opening drawing cooling air from the passenger cabin into the duct to mix with exhaust air from the electric compartment.

8. The apparatus according to claim 7 wherein the duct has an air outlet opening located adjacent to a footwell forward of the seat.

9. The apparatus according to claim 7 further comprising a ramp surface projecting inwardly into an interior of the duct adjacent the air induction.

10. The apparatus according to claim 7 further comprising at least one flow mixing feature inside of the duct contributing to a mixing of the cooling air with the exhaust air flows inside the duct.

11. The apparatus according to claim 10 wherein the at least one flow mixing feature is a fixed vane located adjacent the air induction opening.

12. The apparatus according to claim 7 further comprising at least one flow mixing feature inside of the duct contributing to a mixing of the cooling air with the exhaust air flows inside the duct.

13. The apparatus according to claim 7 further comprising a fan forcing the cooling air through the electric compartment and into the exhaust duct.

14. A method of interior temperature control for an automotive vehicle comprising:
producing a flow of cooling air through an electric compartment located adjacent to a seat and into an exhaust duct passing beneath the seat;
drawing auxiliary cooling air into the exhaust duct from the passenger cabin through at least one induction opening formed in an exterior wall of the exhaust duct; and
expelling a mixture of cooling air and auxiliary cooling air from the exhaust duct into the passenger cabin.

15. The method according to claim 14 wherein the flow of cooling air through the electric compartment is produced by an electrically powered fan.

16. The method according to claim 14 wherein mixing of the cooling air with the auxiliary cooling air is enhanced by at least one flow mixing feature inside of the exhaust duct.

17. The method according to claim 16 wherein the at least one flow mixing feature is a fixed vane located adjacent the air induction opening.
